(19) United States
(12) Patent Application Publication
(10) Pub. No.: US 2024/0020807 A1
(43) Pub. Date: Jan. 18, 2024

(54) Deep Learning-Based Fusion Techniques for High Resolution, Noise-Reduced, and High Dynamic Range Images with Motion Freezing

(71) Applicant: Apple Inc., Cupertino, CA (US)

(72) Inventors: Marius Tico, Mountain View, CA (US); Tiffany J. Cheng, Cupertino, CA (US); Tanmay Nitin Bichu, Mountain View, CA (US)

(21) Appl. No.: 17/812,027

(22) Filed: Jul. 12, 2022

(51) Int. Cl. G06T 5/50; G06T 5/00; G06T 3/40; G06N 3/04

(52) U.S. Cl. CPC G06T 5/50; G06T 5/002; G06T 3/40; G06N 3/0454; G06T 2207/20221; G06T 2207/20016; G06T 2207/20084

(57) ABSTRACT

Electronic devices, methods, and program storage devices for leveraging machine learning to perform high-resolution and low latency image fusion and/or noise reduction are disclosed. An incoming image stream may be obtained from an image capture device, wherein the incoming image stream comprises a variety of differently-exposed captures, e.g., EV0 images, EV− images, EV+ images, long exposure images, EV0/EV− image pairs, etc., which are received according to a particular pattern. When a capture request is received, two or more intermediate assets may be generated from images from the incoming image stream and fed into a neural network that has been trained to fuse and/or noise reduce the intermediate assets. In some embodiments, the resultant fused image generated from the two or more intermediate assets may have a higher resolution than at least one of the images that were used to generate at least one of the two or more intermediate assets.

### CROSS-REFERENCE TO RELATED APPLICATION

This application is related to the commonly-assigned U.S. patent application having Ser. No. 16/564,508, now U.S. Pat. No. 11,151,702 (“the '702 patent”). The '702 patent is also hereby incorporated by reference in its entirety.

### TECHNICAL FIELD

This disclosure relates generally to the field of digital image processing. More particularly, but not by way of limitation, it relates to techniques for leveraging machine learning to perform high-resolution and low latency image fusion and noise reduction for images captured in a wide variety of capturing conditions.

### BACKGROUND

Fusing multiple images of the same captured scene is an effective way of increasing signal-to-noise ratio (SNR) in the resulting fused image. This is particularly important for small and/or thin form factor devices-such as mobile phones, tablets, laptops, wearables, etc.—for which the pixel size of the device's image sensor(s) is often quite small. The smaller pixel size means that there is comparatively less light captured per pixel (i.e., as compared to a full-sized, standalone camera having larger pixel sizes), resulting in more visible noise in captured images-especially in low-light situations.

In image fusion, one of the images to be fused may be designated as the “reference image.” The other images that are to be part of the fusion operation may be designated as “candidate images,” and the candidate images are registered to the reference image before the fusion operation. The decision of which image in a set of captured images should serve as the reference image may be based on, e.g., an image quality measure (such as sharpness, face quality, noise level, etc.), a capture timing measure (such as the image captured closest in time to a received capture request, e.g., if images are being captured in a streaming fashion), a device condition measurement (such as an image captured with the least amount of device rotation), or any other image condition or set of conditions desired by a given implementation.

Often, there can be significant capture time differences between the images that are to be fused, and, therefore, the image registration process may not be able to account for local motion within the images, camera shake, and/or rotation between captured images, etc. In these situations, the differences between corresponding pixels in the reference and candidate images may not just be noise-they may instead be differences caused by a failure of the image registration algorithm. For example, a region(s) of the reference image that changes over time across the captured images by more than a threshold level of motion, e.g., due to object motion or registration errors, may create “ghosting artifacts” in the final fused image.

The appearance and characteristics of ghosting artifacts may vary from image to image. For example, a section of the image that has a certain color in the reference image—but has different colors in the other candidate images-will, when combined with the candidate images, result in a faded look or a false color region that is potentially noticeable by a viewer of the final fused image. On the other hand, an edge area or a textured area that moves over time across the captured images may, when fused, have visible multi-edges (e.g., double edges, triple edges, etc.), which may also be noticeable in the final fused image. Thus, in some embodiments, avoiding ghosting artifacts, e.g., by intelligently weighting the respective contributions of the various images contributing to the fusion at a given pixel location, may be desirable when fusing and/or noise reducing multiple images.

Despite these potential difficulties, in general, by fusing multiple images together, a better-quality resultant image may often be achieved than may be obtained from a single image capture. The multiple image captures used in a given fusion operation may comprise: multiple images captured with the same exposure (e.g., for the purposes of freezing motion), which will be referred to herein as Still Image Stabilization (SIS); multiple images captured with different exposures (e.g., for the purposes of highlight recovery, as in the case of High Dynamic Range (HDR) imaging); or a combination of multiple images captured with shorter and longer exposures, as may be captured when an image capture device's Optical Image Stabilization (OIS) system is engaged, e.g., for the purposes of estimating the moving pixels from the shorter exposures and estimating the static pixels from the long exposure(s). Moreover, the captured images to be fused can come from, e.g., the same camera, multiple cameras with different image sensor characteristics (e.g., cameras with different native sensor resolutions, such as a relatively higher-resolution image sensor and a relatively lower-resolution image sensor), or different image processing workflows (such as video capture and still image capture).

In some prior art image fusion schemes, multiple image heuristics may need to be calculated, tuned, and/or optimized by design engineers (e.g., on a relatively small number of test images), in order to attempt to achieve a satisfactory fusion result across a wide variety of image capture situations. However, such calculations and optimizations are inherently limited by the small size of the test image sets from which they were derived. Further, the more complicated that such calculations and optimizations become, the more computationally-expensive such fusion techniques are to perform on a real-world image capture device.

Thus, what is needed is an approach to leverage machine learning-techniques to improve the fusion and noise reduction of bracketed captures of arbitrary exposure levels and varying resolutions, wherein the improved fusion and noise reduction techniques are optimized over much larger training sets of images and may be performed in a memory-efficient manner. However, as higher and higher resolution image sensors become available for inclusion in consumer-grade electronic devices, new technical challenges are introduced, e.g., in terms of power, memory, and system performance constraints. Moreover, the additional latency involved in capturing such high-resolution photographs may prevent a user from capturing an image of the scene that represents the exact intended moment in time. This may be particularly noticeable when photographing highly dynamic scenes (e.g., sporting events, moving children, pets, etc.).

In such instances, the ability of the camera to capture the exact intended moment in time in such scenes may be equally (or even more) important to the user than the final image's noise level, color reproduction quality, or resolution level. Ideally, a user would like to have a high-resolution photograph that also captures the exact intended moment in time in the captured scene. Thus, presented herein are techniques for performing image capturing and neural network-based image fusion that avoid (or reduce) the effects of system latencies and provide the user with a high resolution (and high quality) output image that accurately represents the scene at the intended moment in time, i.e., that does not exhibit undesirable shutter lag.

### SUMMARY

Devices, methods, and non-transitory program storage devices are disclosed herein that leverage machine learning (ML) and other artificial intelligence (AI)-based techniques (e.g., deep neural networks) to perform high-resolution and low latency image fusion and/or noise reduction, in order to generate low noise and high dynamic range images in a wide variety of capturing conditions and in a memory-efficient and computationally-efficient manner.

More particularly, an incoming image stream may be obtained from an image capture device, wherein the incoming image stream comprises a variety of differently-bracketed image captures, which are, e.g., received in a particular sequence and/or according to a particular pattern. When an image capture request is received, the method may then generate, in response to the capture request, two or more intermediate assets, wherein at least two of the intermediate assets comprise “image-based” intermediate assets, e.g., images generated using a determined one or more images form the incoming image stream. In some embodiments, one or more additional “non-image-based” intermediate assets may also be generated, which may comprise, e.g., motion masks, noise maps, segmentation maps, or other data maps that contain data related to other image-based intermediate assets- and which may be used to aid in the fusion and/or noise reduction operations that leverage machine learning techniques.

According to some embodiments, one type of intermediate asset may comprise a so-called “synthetic reference” (SR) image, which may comprise one or more constituent images from the incoming image stream, and which may be determined in order to attempt to freeze the motion of the captured scene (but which may contain an undesirable amount of noise), while another types of intermediate asset may comprise a so-called “synthetic long” (SL) image, which may also comprise one or more constituent images from the incoming image stream, and which may be determined to attempt to reduce the amount of noise present in the captured scene (but which may contain an undesirable amount of motion blurring). The terms “synthetic” or “synthesized,” in this context, are used to denote the fact that such assets are not typically directly captured by the image capture device, but instead may be generated or synthesized programmatically using a combination of actual image assets that are captured by the image capture device. In some such embodiments, the SR image may be comprised of images having an aggregate exposure time that is less than the aggregate exposure time of the images that are combined to form the SL image.

According to some embodiments, one or more high-resolution image assets (e.g., images having a higher native resolution than the constituent images from the incoming image stream described above as being used to generate the SR and/or SL intermediate assets) may also be captured in response to receiving an image capture request. As will be described herein, such high-resolution images assets may be used to transfer additional detail to the other lower-resolution image assets used in the neural image fusion process in an intelligent way (e.g., only in portions of the image wherein less than a threshold level of estimated motion is present). In some cases, the final generated output image may have the same resolution as the one or more high-resolution image assets. In other cases, the one or more high-resolution image assets may be downscaled before the neural image fusion process with the other lower-resolution image assets, resulting in a final generated output image having a resolution that is still higher than the other lower-resolution image assets, though not as great as the native resolution of the originally-captured high-resolution image assets. According to still other embodiments, one or more long exposure image assets may also be captured in response to receiving the image capture request and then used in an intelligent fashion in the neural image fusion process.

Next, the neural image fusion and/or noise reduction process may be performed on the generated intermediate assets, thereby generating an output image that has fused and/or denoised the various constituent images, intermediate assets (and even non-image-based intermediate assets) according to the output of one or more neural networks, wherein the generated output image has a greater resolution than at least one of the constituent images or intermediate assets used in the generation of the output image.

According to some embodiments, a proxy asset may be generated based upon the generated intermediate assets and then provided for display, e.g., via a user interface of an electronic device, prior to completing the generation of the output image using the aforementioned neural image fusion techniques. The proxy asset may comprise a quick or coarse image fusion result, e.g., that does not benefit from the final output of the aforementioned fusion and/or noise reduction processing determined by the neural network(s)—but which may instead serve as a temporary visual placeholder for a user of the electronic device, e.g., in the event that the high-resolution neural image fusion processing takes additional time to complete. In some instances, once the neural image fusion processing has completed, any generated proxy asset may be replaced, e.g., in a user's media library or electronic device storage, with the final output image generated using the aforementioned processes leveraging machine learning techniques to drive fusion and/or noise reduction determinations.

As mentioned above, various electronic device embodiments are disclosed herein. Such electronic devices may include one or more image capture devices, such as optical image sensors/camera units; a display; a user interface; one or more processors; and a memory coupled to the one or more processors. Instructions may be stored in the memory, the instructions causing the one or more processors to execute instructions to: obtain an incoming image stream from the one or more image capture devices (e.g., an incoming image stream comprising images with two or more different exposure values); receive an image capture request via the user interface; generate, in response to the image capture request, two or more intermediate assets, wherein: a first intermediate asset of the generated two or more intermediate assets comprises an image generated using a determined first one or more images from the incoming image stream, and wherein the first intermediate asset has a first resolution; and a second intermediate asset of the generated two or more intermediate assets comprises an image generated using a determined second one or more images from the incoming image stream, wherein at least one of the determined second one or more images has a second resolution, and wherein the second resolution is greater than the first resolution; feed the first and second intermediate assets into a first neural network, wherein the first neural network is configured to combine the first and second intermediate assets to generate an output image having a resolution greater than the first resolution; and generate the output image using the first neural network.

In some embodiments, the first intermediate asset may be upscaled to match the resolution of the second intermediate asset before the first neural network combines the first and second intermediate assets to generate the output image having a resolution greater than the first resolution. In some embodiments, the determined first one or more images from the incoming image stream may comprise two or more images obtained from the incoming image stream prior to receiving the image capture request, while the determined second one or more images may be images obtained from the incoming image stream after receiving the image capture request.

In some embodiments, generating the second intermediate asset further comprises transferring image details from the at least one of the determined second one or more images having the second resolution to an image formed from at least one of the first one or more images from the incoming image stream. In some such embodiments, the transferring of image details may be performed according to a motion mask that is formed based on pixel comparisons between corresponding portions of the at least one of the determined second one or more images having the second resolution and the image formed from at least one of the first one or more images from the incoming image stream.

In some embodiments, at least one of the determined second one or more images having the second resolution is downscaled before transferring image details to the image formed from at least one of the first one or more images from the incoming image stream, and in some such embodiments, the image formed from at least one of the first one or more images from the incoming image stream may also be upscaled from its native resolution, e.g., to match the downscaled resolution of the at least one of the determined second one or more images, before the image details are transferred to the image formed from at least one of the first one or more images from the incoming image stream.

In other embodiments, generating the first intermediate asset may further comprise: generating a third intermediate asset from a third one or more of the determined first one or more images from the incoming image stream; generating a fourth intermediate asset from a fourth one or more of the determined first one or more images from the incoming image stream; and then feeding the third and fourth intermediate assets into a second neural network, wherein the second neural network is configured to combine the third and fourth intermediate assets and generate the first intermediate asset. In some cases, the second neural network may be a deep neural image fusion network, e.g., as described in the '702 patent. In some such cases, the third intermediate asset may be sharper than the fourth intermediate asset, while the fourth intermediate asset may be less noisy than the third intermediate asset, such that the second neural network may be trained to take advantage of each image's complimentary characteristics to form a higher-quality intermediate fused image to serve as the first intermediate asset.

In still other embodiments, instructions may be stored in a memory, with the instructions causing the one or more processors to execute instructions to: obtain an incoming image stream from one or more image capture devices; receive an image capture request; generate, in response to the image capture request, two or more intermediate assets, wherein: a first intermediate asset of the generated two or more intermediate assets comprises an image generated using a determined first one or more images from the incoming image stream, and wherein the first intermediate asset has a first resolution; and a second intermediate asset of the generated two or more intermediate assets comprises an image generated using a determined second one or more images from the incoming image stream, wherein at least one of the determined second one or more images has a second resolution, and wherein the second resolution is greater than the first resolution; feed the first and second intermediate assets into a first neural network, wherein the first neural network is configured to: (1) transfer image details from portions of the second intermediate asset exhibiting less than a threshold level of estimated motion to corresponding portions of the first intermediate asset; and (2) combine the first and second intermediate assets to generate an output image having a resolution greater than the first resolution; and then generate the output image using the first neural network.

Various methods of performing high-resolution and low latency machine learning-enhanced image fusion and/or noise reduction are also disclosed herein, in accordance with the various electronic device embodiments enumerated above. Non-transitory program storage devices are also disclosed herein, which non-transitory program storage devices may store instructions for causing one or more processors to perform operations in accordance with the various electronic device embodiments enumerated above.

### BRIEF DESCRIPTION OF THE DRAWINGS

FIG. 1A illustrates an exemplary incoming image stream that may be used to generate a one or more intermediate assets to be used in a machine learning-enhanced image fusion and/or noise reduction method, according to one or more embodiments.

FIG. 1B illustrates another exemplary incoming image stream that may be used to generate one or more intermediate assets to be used in a machine learning-enhanced image fusion and/or noise reduction method, according to one or more embodiments.

FIG. 2 illustrates an overview of a process for performing high-resolution and low latency machine learning-enhanced image fusion and/or noise reduction, according to one or more embodiments.

FIG. 3 is an example of a neural network architecture that may be used for performing high-resolution and low latency machine learning-enhanced image fusion and/or noise reduction, according to one or more embodiments.

FIG. 4 is another example of a neural network architecture that may be used for performing high-resolution and low latency machine learning-enhanced image fusion and/or noise reduction, according to one or more embodiments.

FIG. 5 is yet another example of a neural network architecture that may be used for performing high-resolution and low latency machine learning-enhanced image fusion and/or noise reduction, according to one or more embodiments.

FIGS. 6A-6C are flow charts illustrating a method of performing high-resolution and low latency machine learning-enhanced image fusion and/or noise reduction using one or more intermediate assets, according to one or more embodiments.

FIG. 7 is a flow chart illustrating another method of performing high-resolution and low latency machine learning-enhanced image fusion and/or noise reduction using one or more intermediate assets, according to one or more embodiments.

FIG. 8 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes, and it may not have been selected to delineate or circumscribe the inventive subject matter, and, thus, resort to the claims may be necessary to determine such inventive subject matter. Reference in the specification to “one embodiment” or to “an embodiment” means that a particular feature, structure, or characteristic described in connection with the embodiments is included in at least one embodiment of one of the inventions, and multiple references to “one embodiment” or “an embodiment” should not be understood as necessarily all referring to the same embodiment.

Discussion will now turn to the nomenclature that will be used herein to refer to the various differently-exposed images from an incoming image stream. As in conventional bracket notation, “EV” stands for exposure value and refers to a given exposure level for an image (which may be controlled by one or more settings of a device, such as an image capture device's shutter speed and/or aperture setting). Different images may be captured at different EVs, with a one EV difference (also known as a “stop”) between images equating to a predefined power difference in exposure. Typically, a stop is used to denote a power of two difference between exposures. Thus, changing the exposure value can change an amount of light received for a given image, depending on whether the EV is increased or decreased. For example, one stop doubles (or halves) the amount of light received for a given image, depending on whether the EV is increased (or decreased), respectively.

The “EV0” image in a conventional bracket refers to an image that is captured using an exposure value as determined by an image capture device's exposure algorithm, e.g., as specified by an Auto Exposure (AE) mechanism. Generally, the EV0 image is assumed to have the ideal exposure value (EV) given the lighting conditions at hand. It is to be understood that the use of the term “ideal” in the context of the EV0 image herein refers to an ideal exposure value, as calculated for a given image capture system. In other words, it is a system-relevant version of ideal exposure. Different image capture systems may have different versions of ideal exposure values for given lighting conditions and/or may utilize different constraints and analyses to determine exposure settings for the capture of an EV0 image.

The term “EV−” image refers to an underexposed image that is captured at a lower stop (e.g., 0.5, 1, 2, or 3 stops) than would be used to capture an EV0 image. For example, an “EV−1” image refers to an underexposed image that is captured at one stop below the exposure of the EV0 image, and “EV−2” image refers to an underexposed image that is captured at two stops below the exposure value of the EV0 image. The term “EV+” image refers to an overexposed image that is captured at a higher stop (e.g., 0.5, 1, 2, or 3) than the EV0 image. For example, an “EV+1” image refers to an overexposed image that is captured at one stop above the exposure of the EV0 image, and an “EV+2” image refers to an overexposed image that is captured at two stops above the exposure value of the EV0 image.

For example, according to some embodiments, the incoming image stream may comprise a combination of: EV−, EV0, EV+, and/or other longer exposure images. It is further noted that the image stream may also comprise a combination of arbitrary exposures, as desired by a given implementation or operating condition, e.g., EV+2, EV+4, EV−3 images, etc.

As mentioned above, in image fusion, one of the images to be fused is typically designated as the reference image for the fusion operation, to which the other candidate images involved in the fusion operation are registered. Reference images are often selected based on being temporally close in capture time to the moment that the user intends to “freeze” in the captured image. In order to more effectively freeze the motion in the captured scene, reference images may have a relatively shorter exposure time (e.g., shorter than a long exposure image) and thus have undesirable amounts of noise. As such, reference images may benefit from being fused with one or more additional images, in order to improve the reference image's original noise characteristics, while still sufficiently freezing the desired moment in the scene. Thus, according to some embodiments, enhanced reference images may be synthesized from multiple captured images that are fused together (the result of which will be referred to herein as a “synthetic reference image” or “SR” image). According to other embodiments, the synthetic reference image may also simply be the result of selecting a single bracketed capture (i.e., without fusion with one or more other bracketed captures). For example, in bright lighting capture scenarios, a single EV− image may serve as the synthetic reference image, while, in low lighting capture scenarios, a single EV0 image may serve as the synthetic reference image. According to still other embodiments, a synthetic reference image may be further upscaled and/or enhanced with additional details from particular portions of another high-resolution image captured in response to the image capture request, thereby creating a so-called “high-resolution synthetic reference image,” which may itself be used an intermediate asset in a neural image fusion process designed to generate an output fused image having a higher resolution than the original synthetic reference image.

According to some embodiments, long exposure images may comprise an image frame captured to be over-exposed relative to an EV0 exposure setting. In some instances, it may be a predetermined EV+ value (e.g., EV+1, EV+2, etc.). In other instances, the exposure settings for a given long exposure image may be calculated on-the-fly at capture time (e.g., within a predetermine range). A long exposure image may come from a single image captured from a single camera, or, in other instances, a long exposure image may be synthesized from multiple captured images that are fused together (the result of which will be referred to herein as a “synthetic long image,” “synthetic long exposure image” or “SL” image). According to other embodiments, the synthetic long image may also simply be the result of selecting a single bracketed capture (i.e., without fusion with one or more other bracketed captures). For example, a single EV+2 long exposure image may serve as the synthetic long image in a given embodiment.

Synthetic reference images, high-resolution synthetic reference images, and synthetic long images may also be referred to herein as examples of “intermediate assets,” to reflect the fact that they are not typically images that are captured directly by an image senor (e.g., other than the scenarios described above, wherein a particular single bracketed image capture may be selected to serve as an intermediate asset). Instead, intermediate assets are typically synthesized or fused from two or more directly-captured images by the image sensor. Intermediate assets may be referred to as “intermediate,” e.g., due to the fact that they may be generated (or selected) and used during an intermediate time period between the real-time capture of the images by the image sensors of the device and the generation of a final, fused output image. The intelligent use of intermediate assets may allow for fusion operations to benefit (to at least some extent) from both the additional light information captured by a larger number of bracketed exposure captures, as well as the additional detail that is recoverable from higher-resolution image captures, while still maintaining the processing and memory efficiency benefits of performing the actual fusion operation (e.g., leveraging potentially processing-intensive deep learning techniques) using only the smaller number of intermediate assets.

In instances where the image capture device is capable of performing OIS, the OIS may be actively stabilizing the camera and/or image sensor during capture of the long exposure image and/or one or more of the other captured images. (In other embodiments, there may be no OIS stabilization employed during the capture of the other, i.e., non-long exposure images, or a different stabilization control technique may be employed for such non-long exposure images). In some instances, an image capture device may only use one type of long exposure image. In other instances, the image capture device may capture different types of long exposure images, e.g., depending on capture conditions. For example, in some embodiments, a synthetic long exposure image may be created when the image capture device does not or cannot perform OIS, while a single long exposure image may be captured when an OIS system is available and engaged at the image capture device.

According to some embodiments, in order to recover a desired amount of shadow detail in the captured image, some degree of overexposure (e.g., EV+2) may intentionally be employed in bright scenes and scenes with medium brightness. Thus, in certain brighter ambient light level conditions, the long exposure image itself may also comprise an image that is overexposed one or more stops with respect to EV0 (e.g., EV+3, EV+2, EV+1, etc.). To keep brightness levels consistent across long exposure images, the gain may be decreased proportionally as the exposure time of the capture is increased, as, according to some embodiments, brightness may be defined as the product of gain and exposure time.

In some embodiments, long exposure images may comprise images captured with greater than a minimum threshold exposure time, e.g., 50 milliseconds (ms) and less than a maximum threshold exposure time, e.g., 250 ms, 500 ms, or even 1 second. In other embodiments, long exposure images may comprise images captured with a comparatively longer exposure time than a corresponding normal or “short” exposure image for the image capture device, e.g., an exposure time that is 4 to 30 times longer than a short exposure image's exposure time. In still other embodiments, the particular exposure time (and/or system gain) of a long exposure image may be further based, at least in part, on ambient light levels around the image capture device(s), with brighter ambient conditions allowing for comparatively shorter long exposure image exposure times, and with darker ambient conditions allowing the use of comparatively longer long exposure image exposure times. In still other embodiments, the particular exposure time (and/or system gain) of a long exposure image may be further based, at least in part, on whether the image capture device is using an OIS system during the capture operation.

It is to be noted that the noise level in a given image may be estimated based, at least in part, on the system's gain level (with larger gains leading to larger noise levels). Therefore, in order to have low noise, an image capture system may desire to use small gains. However, as discussed above, the brightness of an image may be determined by the product of exposure time and gain. So, in order to maintain the image brightness, low gains are often compensated for with large exposure times. However, longer exposure times may result in motion blur, e.g., if the camera doesn't have an OIS system and/or if there is significant camera shake during the long exposure image capture. Thus, for cameras that have an OIS system, exposure times could range up to the maximum threshold exposure time in low light environments, which would allow for the use of a small gain- and hence less noise. However, for cameras that do not have an OIS systems, the use of very long exposure times will likely result in motion blurred images, which is often undesirable. Thus, as may now be understood, the long exposure image's exposure time may not always be the maximum threshold exposure time allowed by the image capture device.

According to some embodiments, the incoming image stream may comprise a particular sequence and/or particular pattern of exposures. For example, according to some embodiments, the sequence of incoming images may comprise: EV0, EV−, EV0, EV−, and so forth. In other embodiments, the sequence of incoming images may comprise only EV0 images. In response to a received capture request, according to some embodiments, the image capture device may take one (or more) long exposure images. After the long exposure capture, the image capture device may return to a particular sequence of incoming image exposures, e.g., the aforementioned: EV0, EV−, EV0, EV− sequence. The sequence of exposures may, e.g., continue in this fashion until a subsequent capture request is received, the camera(s) stop capturing images (e.g., when the user powers down the device or disables a camera application), and/or one when or more operating conditions may change. In still other embodiments, the image capture device may capture one or more additional EV0 images in response to the received capture request and then fuse the additional EV0 exposure images (along with, optionally, one or more additional EV0 images captured prior to the received capture request, if so desired) into a synthetic long exposure image, as discussed above, which synthetic long image may then be treated as a single image intermediate asset for the purposes of the machine learning-enhanced image fusion and/or noise reduction processes described herein (and/or combined with one or more other assets to form a different type of intermediate asset). According to some embodiments, the images in the incoming image stream may be captured as part of a preview operation of a device, or otherwise be captured while the device's camera(s) are active, so that the camera may more quickly react to a user's image capture request. Returning to the sequence of incoming images may ensure that the device's camera(s) are ready for the next image capture request.

According to some embodiments, the terms “high-resolution” and “low-resolution” may be used herein to refer to relative differences in the number of pixels natively captured by an image sensor for a particular captured image. For example, a “high-resolution” image may refer to an image that is captured with a greater number of pixels than a “low-resolution” image in the same incoming image stream. In some embodiments, high-resolution images may comprise images captured with greater than a minimum threshold resolution, e.g., greater than 12 megapixels (MP), greater than 24 MP, etc.

In other embodiments, as mentioned above, high-resolution image may comprise images captured natively with a comparatively greater resolution level than a corresponding normal or “low” resolution image for the image capture device, e.g., a resolution level that is 2×, 4×, 8×, or 9× etc., larger than a so-called low-resolution image's resolution. In some cases, a higher-resolution image sensor may have a pixel color pattern that mirrors an existing color filter array (CFA) pattern, e.g., a Bayer color filter array pattern used by a “low resolution” image sensor, but with more granular detail. For example, if a typical Bayer pattern followed a pixel pattern of:

### BGBG . . .

### GRGR . . .

then a 4× higher-resolution image sensor may follow the same Bayer color filter pattern, but, instead, further subdivide each pixel location from the “low resolution” Bayer CFA image sensor pattern into a 2×2 grid of pixels of the same color, thereby causing the 8 pixels in the example pattern produced above to instead be represented on the sensor as 8×4 or 32 pixels on the higher-resolution image sensor, in a pattern such as:

### BBGGBBGG . . .

### BBGGBBGG . . .

### GGRRGGRR . . .

### GGRRGGRR . . .

Other color filter array patterns and ways of achieving higher-resolution images are also possible, with the above example being but one such option. In still other embodiments, as will be explained in greater detail below, the particular resolution of a high-resolution image as used in a neural image fusion process may be further based, at least in part, on an amount of binning applied the image capture device(s), with higher levels of binning resulting in smaller and smaller sized high-resolution image representations. In some cases, determining an amount of binning may be a tradeoff between a loss in image detail level and a gain in overall processing/memory/power efficiency by being able to operate on images having smaller overall memory footprints.

Exemplary Incoming Image Streams

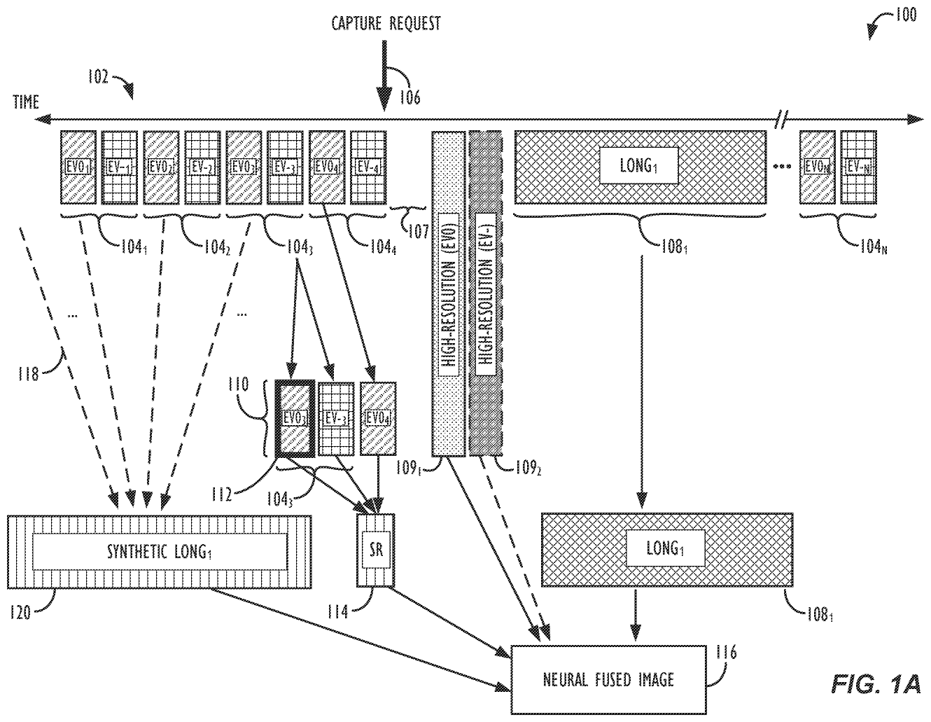

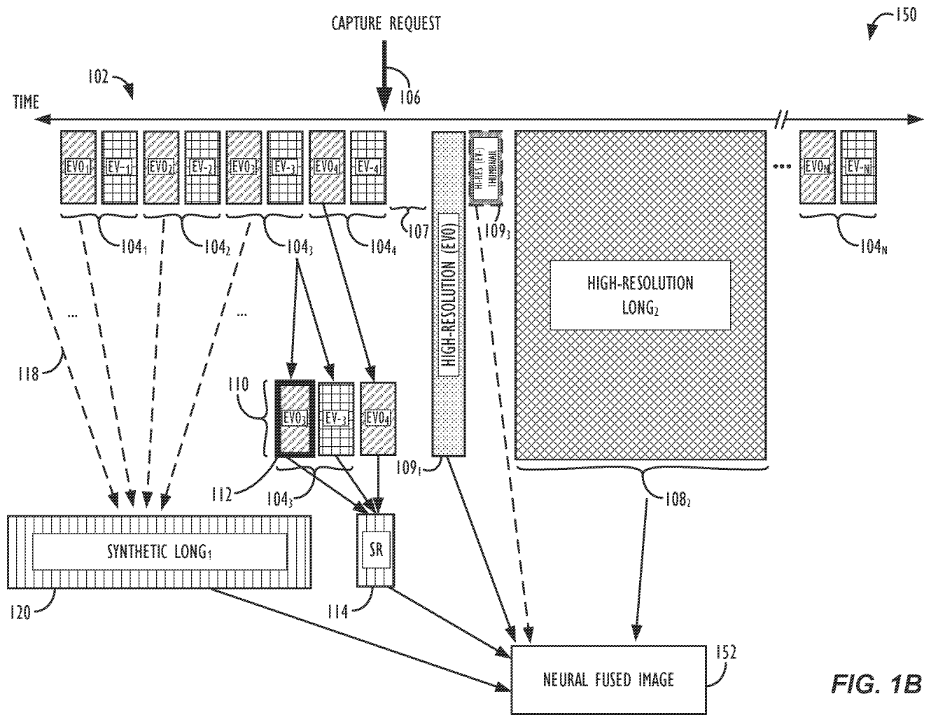

Referring now to FIG. 1A, an exemplary incoming image stream 100 that may be used to generate one or more intermediate assets to be used in a machine learning-enhanced image fusion and/or noise reduction method is illustrated, according to one or more embodiments. Images from incoming image stream 100 may be captured along a timeline, e.g., exemplary image capture timeline 102, which runs from left to right across FIG. 1A. It is to be understood that this timeline is presented merely for illustrative purposes, and that a given incoming image stream could be captured for seconds, minutes, hours, days, etc., based on the capabilities and/or needs of a given implementation.

According to some embodiments, EV0 image frames in the incoming image stream may, by default, be captured according to a first frame rate, e.g., 15 frames per second (fps), 30 fps, 60 fps, etc. In some embodiments, this frame rate may remain constant and uninterrupted, unless (or until) an image capture request 106 is received at the image capture device. In other embodiments, the frame rate of capture of EV0 image frames may vary over time, based on, e.g., one or more device conditions, such as device operational mode, available processing resources, ambient lighting conditions, thermal conditions of the device, etc.

In other embodiments, one or more captured EV0 images may be paired with another image as part of a so-called “secondary frame pair” (SFP). The SFP, according to some embodiments, may comprise an image that is captured and read out from the image sensor consecutively, e.g., immediately following, the capture of the corresponding EV0 image. In some embodiments, the SFP may comprise an EV0 image and: an EV−1 image frame, an EV−2 image frame, or an EV−3 image frame, etc. EV− images will have a lower exposure time and thus be somewhat darker and have more noise than their EV0 counterpart images, but they may do a better job of freezing motion and/or representing detail in the darker regions of images.

In the example shown in FIG. 1A, SFPs 104 are captured sequentially by the image capture device (e.g., 104₁, 104₂, 104₃, 104₄, and so forth), with each SFP including two images with differing exposure values, e.g., an EV0 image and a corresponding EV− image. Note that the EV0 and EV− images illustrated in FIG. 1A use a subscript notation (e.g., EV−₁, EV−₂, EV−₃, EV−₄, and so forth). This subscript is simply meant to denote different instances of images being captured (and not different numbers of exposure stops). It is to be understood that, although illustrated as pairs of EV0 and EV− images in the example of FIG. 1A, any desired pair of exposure levels could be utilized for the images in an SFP, e.g., an EV0 image and an EV−2 image, or an EV0 image and in EV−3 image, etc. In other embodiments, the SFP may even comprise more than two images (e.g., three or four images), based on the capabilities of the image capture device.

In some embodiments, the relative exposure settings of the image capture device during the capture of the images comprising each SFP may be driven by the image capture device's AE mechanism. Thus, in some instances, the exposure settings used for each SFP may be determined independently of the other captured SFPs. In some instances, the AE mechanism may have a built-in delay or lag in its reaction to changes in ambient lighting conditions, such that the AE settings of the camera do not change too rapidly, thereby causing undesirable flickering or brightness changes. Thus, the exposure settings for a given captured image (e.g., EV0 image, EV− image, and/or EV+ image) may be based on the camera's current AE settings. Due to the consecutive nature of the readouts of the images in an SFP, it is likely that each image in the SFP will be driven by the same AE settings (i.e., will be captured relative to the same calculated EV0 settings for the current lighting conditions). However, if the delay between captured images in an SFP is long enough and/or if the camera's AE mechanism reacts to ambient lighting changes quickly enough, in some instances, it may be possible for the images in a given SFP to be driven by different AE settings (i.e., the first image in the SFP may be captured relative to a first calculated EV0 setting, and the second image in the SFP may be captured relative to a second calculated EV0 setting). Of course, outside of the context of SFPs, it may also be possible for consecutive captured images, e.g., from an incoming image stream, to be captured relative to different calculated EV0 settings, again based, e.g., on changing ambient lighting conditions and the rate at which the camera's AE mechanism updates its calculated EV0 settings.

According to some embodiments, the capture frame rate of the incoming image stream may change based on the ambient light levels (e.g., capturing at 30 frames-per-second, or fps, in bright light conditions and at 15 fps in low light conditions). In one example, assuming that the image sensor is streaming captured images at a rate of 30 fps, the consecutive SFP image pairs (e.g., EV0, EV−) are also captured at 30 fps. The time interval between any two such SFP captures would be 1/30^{th} of a second, and such interval may be split between the capturing of the two images in the SFP, e.g., the EV0 and EV− images. According to some embodiments, the first part of the interval may be used to capture the EV0 image of the pair, and last part of the interval may be used to capture the EV− image of the pair. Of course, in this 30 fps example, the sum of the exposure times of the EV0 and EV− images in a given pair cannot exceed 1/30^{th} of a second. In still other embodiments, the capture of the EV− image from each SFP may be disabled based on ambient light level. For example, below a threshold scene lux level, the capture of the EV− image from each SFP may simply be disabled, since any information captured from such an exposure may be too noisy to be useful in a subsequent fusion operation.

Moving forward along timeline 102 to the capture request 106, according to some embodiments, one or more high-resolution images 109 (e.g., a pair of high-resolution images, including an EV0 high-resolution image 109₁ and an EV− high-resolution image 109₂) may be captured by the image capture device in response to the receipt of the capture request 106. As will be explained in further detail below with reference to FIG. 1B, capturing a pair of EV0/EV− high-resolution is just one example of the way that one or more high-resolution image assets (or image assets derived from a high-resolution image capture) may be included into the bracketed capture scheme in a given embodiment. In some embodiments, one or more additional long exposure images, e.g. long exposure image 108₁ may also be captured by the image capture device in response to the receipt of the capture request 106 (e.g., after the capture of any desired high-resolution image assets). According to some embodiments, a system latency 107 may exist in the image capture stream following the receipt of an image capture request 106. In some cases, an additional intentional delay may also be built in to the image capture process following the receipt of an image capture request, e.g., so that any shaking or vibrations caused by a user's touching or selection of a capture button on the image capture device (e.g., either a physical button or software-based user interface button or other graphical element) may be diminished before the initiation of any long exposure image captures, which, although more likely to produce a low-noise image, are more prone to blurring, and thus lack of sharpness, due to the amount of time the shutter stays open during the capture of the long exposure image. As may now be understood, due to various system latencies (as well as the reaction time of the photographer), the image bracket that best represents the captured scene at the instant the user presses the shutter to indicate a desire to capture an image may actually be an image bracket that was captured prior to the shutter press. In other words, in the example of FIG. 1A, it may actually be an image from one of the SFPs 104 (e.g., 104₁, 104₂, 104₃, 104₄,) that best captures or “freezes” the moment in time that the photographer intended to capture, and thus may serve as the best “reference” image, against which the other image assets used in the fusion process should be aligned.

Based on the evaluation of one or more capture conditions, the image capture device may then select two or more images 110 for inclusion in an image fusion operation to generate an intermediate asset, e.g., a synthetic reference (SR) image. According to some embodiments, the images selected to fuse together to form the synthetic reference may be chosen based, at least in part, on their sharpness, or any other desired criteria. In the example of FIG. 1A, the images: EV0₃, EV−₃, and EV0₄ have been selected for inclusion in the synthetic reference fusion operation, and, in particular, one of the images, EV0₃ (from secondary frame pair 104₃) may be selected to serve as the reference image for the synthetic reference fusion operation. The resulting synthetic reference image is illustrated as intermediate asset SR 114 in FIG. 1A. It is to be understood that, in some embodiments, a selected EV0 reference image may be fused with one or more EV− images from: the same SFP, a previous SFP, the next SPF, or some other SFP, based on any desired criteria (e.g., proximity in capture time to the reference EV0 image for the synthetic reference image fusion operation).

The image capture device may also select two or more additional relatively shorter exposure EV0 and EV− images (e.g., secondary frame pairs 104₁-104₃ in FIG. 1A, as well as any other desired EV0 or EV− images, e.g., captured before or after the capture request). In the example of FIG. 1A, a set of images 118, are selected and fused together (e.g., via an averaging algorithm) into another type of intermediate asset, referred to herein as a “synthetic long exposure image,” a “synthetic long” image, or, simply, an “SL” image (e.g., SYNTHETIC LONG₁ 120 in FIG. 1A). In other embodiments, a different number of EV0 (or other relatively shorter exposure) images may be fused together to form the synthetic long exposure image, as is desired for a given implementation. For example, in a given embodiment, only the EV0 images captured prior to the capture request may be used, only the EV0 images captured after the capture request may be used, or a desired combination of EV0 images captured both prior to and after the capture request may be used. In still other embodiments, one or more EV− images captured prior to and/or after the capture request may also be used to form the synthetic long exposure image. For example, in one embodiment, a synthetic long exposure image may be formed by combining various selected EV0 and EV− images, e.g., via a weighted combination, where highlight regions are taken from the various EV− images, and the remaining parts of the scene are taken from the various EV0 images.

In still other embodiments, an additional blurred frame elimination process may be executed on the set of images 118 selected for fusion into the synthetic long exposure image 120. For example, any EV0 frames that have greater than a threshold amount of blur (wherein blur amount may be estimated based on one or more criteria, e.g., information output by gyroscopes or other motion sensors, autofocus score metadata, or other metadata) may be discarded from use in the creation of the synthetic long exposure intermediate asset image. In some embodiments, the permissible threshold amount of blur may be determined based on a comparison to the amount of blur in the selected reference image (i.e., EV0₃ 112 in the case of FIG. 1A).

In some cases, a synthetic long exposure image may be desirable because a given implementation may not want to capture a long exposure image in response to a capture request, as it may disrupt a video stream that is concurrently being captured by the image capture device when the image capture request is received. In some instances, when a synthetic long exposure image is captured (e.g., as opposed to an actual long exposure image, e.g., image 108₁ in FIG. 1A), the minimum time interval required between consecutive image capture operations may be shortened (i.e., as compared to the case when a long exposure image is captured in response to the capture request). However, some scenes may be so dark that the use of a synthetic long exposure image would not be desirable, e.g., due to the increased noise that would result in the constituent short exposure images used to create the synthetic long exposure image.

Once the synthetic long exposure image 120 has been created, it may be fused with the other selected images and/or intermediate assets from the incoming image stream (e.g., synthetic reference image 114, high resolution image(s) 109, etc.), in order to form the final neural fused image 116.

As alluded to above, in some situations (e.g., sufficiently stable capture conditions), the image capture device may also capture and select one or more relatively longer exposure images, e.g., LONG₁ image 108₁ (as illustrated in FIG. 1A) for inclusion in a final image fusion operation. In the example of FIG. 1A, the SR image 114 (generated from EV0₃, EV−₃, and EV0₄) and the LONG₁ image 108₁ have been selected (along with other image assets and/or intermediate assets) for inclusion in the final neural image fusion operation 116.

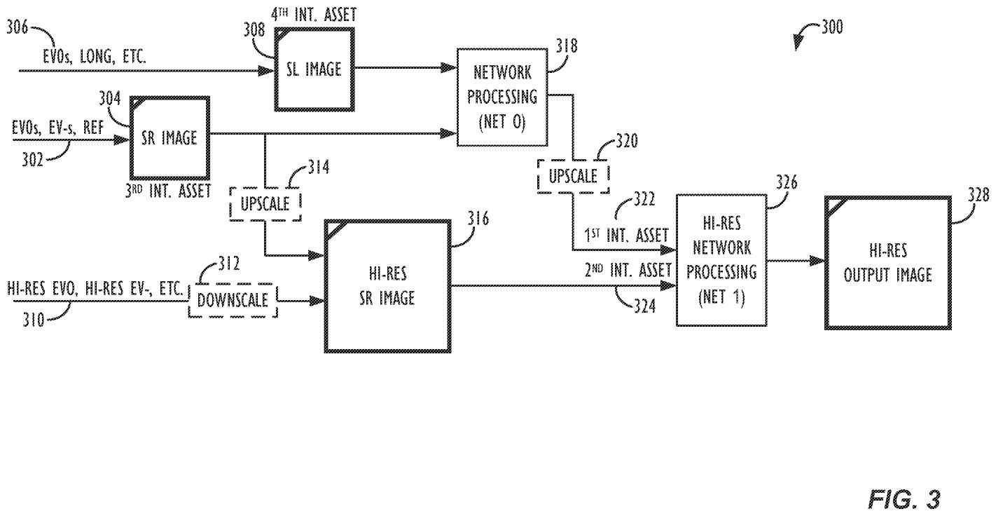

According to some embodiments, one image may be selected to serve as the reference image for the final neural image fusion operation 116, e.g., the image (or synthetic image, e.g., an intermediate asset) having a capture time closest to the capture request 106, the image (or synthetic image) having the lowest aggregate exposure time, the sharpest image, the synthetic reference image 114, etc. As will be explained in further detail below with reference to FIGS. 3, 4, and 5, machine learning techniques, e.g., deep neural networks, may be leveraged to determine a preferred or optimal way to fuse and/or denoise the images (or synthetic images) that are used in the final image fusion operation 116.

According to some embodiments, as an initial step, one or more of the SFPs may be identified as “candidate reference image pairs,” i.e., an image pair from which the reference image for the synthetic reference image fusion operation may be taken. In some embodiments, the candidate reference image pairs may comprise a predetermined number of SFPs captured prior to (and/or after) a received capture request, e.g., image capture request 106. For example, in some embodiments, the candidate reference image pairs may comprise the three or four SFPs captured prior to the capture request. Next, a particular candidate reference image pair may be selected as the “selected reference image pair.” For example, the selected reference image pair may be selected based, at least in part, on a comparison of the sharpness scores of the pair's respective EV0 image to sharpness scores of the respective EV0 images of the other candidate reference image pairs. In some instances, the selected reference image pair may simply be the SFP having the sharpest EV0 image. In other embodiments, the determination of the selected reference image pair may be based on one or more timing measures or image/device capture conditions. As mentioned above, in the example illustrated in FIG. 1A, secondary frame pair 104₃ has been selected as the selected reference image pair for the SR image, due, e.g., to the fact that EV0₃ may be the sharpest EV0 image from among the EV0 images being considered for the fusion operation (or whatever image aspect or combination of aspects the reference image selection decision may be based on for a given implementation).

According to such embodiments, from the selected reference image pair (e.g., comprising one EV0 image and one EV− image), the process may select one image to serve as the reference image 112 for the creation of the SR image, e.g., either the EV0 image or the EV− image from the selected reference image pair. The determination of which image from the selected reference image pair to select to serve as the reference image for the SR image fusion operation may be based on a number of factors. For example, the determination may be based on various image aspects, such as: noise level, sharpness, and/or the presence (or prevalence) of ghosting artifacts. For example, in order to ensure lower noise, the EV0 image may be selected as the reference image, especially in lower ambient light level conditions. On the other hand, e.g., in dynamic scenes with moving objects and/or people, the EV− image may be preferred as the reference image because it ensures a shorter exposure time and hence less motion blurring than the corresponding EV0 image from the selected reference image pair. In the example illustrated in FIG. 1A, EV0₃ has been selected to serve as the reference image 112 for the fusion operation performed to generate the SR image intermediate asset 114 (as indicated by the thicker border line on EV0₃). Once a reference image is selected, each of the other selected images 110, e.g., including EV−₃ and EV0₄ in the example illustrated in FIG. 1A, may be registered with respect to the reference image 112 in order to form the synthetic reference image intermediate asset 114.

The final fusion operation of the selected images and/or intermediate assets from the incoming image stream 100 (e.g., SR image 114, synthetic long image, SYNTHETIC LONG₁ 120, long exposure image, LONG₁ image 108₁, and one or more images derived from high-resolution image 109, as illustrated in FIG. 1A) will result in the final neural fused output image 116 (wherein the modifier “neural” in this context refers to the fact that the output image 116 is fused via the usage of one or more deep neural networks (DNNs)). As explained in the '702 patent, the decision of what weights to give the various images and/or image-based intermediate assets included in the fusion operation (as well as a set of weights to use to denoise the resulting fused image) may be based on one or more sets of output filters produced by one or more deep neural networks. In some such embodiments, the determination of the fusion weights and denoising weights may be decoupled, i.e., determined independently, by the deep neural networks. As also illustrated in the example of FIG. 1A, in some embodiments, after the capture of the long exposure image(s) following the capture request 106, the image capture stream may go back to capturing SFPs 104_{N}, EV0 images, or whatever other pattern of images is desired by a given implementation, e.g., until the next capture request is received, thereby triggering the capture of another high-resolution image(s), and/or long exposure image(s) (and/or the generation of one or more synthetic intermediate assets to be used in the final neural image fusion operation), or until the device's camera functionality is deactivated.

Referring now to FIG. 1B, another exemplary incoming image stream 150 that may be used to generate one or more intermediate assets to be used in a machine learning-enhanced image fusion and/or noise reduction method is shown, according to one or more embodiments. In contrast with FIG. 1A, in the incoming image stream 150 shown in FIG. 1B, the image capture device captures a high-resolution long exposure image, HIGH-RESOLUTION LONG₂ 108₂, rather than a “normal” or relatively lower-resolution long exposure image, such as LONG₁ image 108₁ in FIG. 1A. In the example illustrated in FIG. 1B, exemplary HIGH-RESOLUTION LONG₂ 108₂ is captured with the same native resolution as high-resolution EV0 image 109₁, just with a longer exposure time. In some variations, rather than utilizing a full, high-resolution long exposure image (which may be too processing-intensive), an image sensor may be configured to provide a “binned” version of the high-resolution long exposure image to the neural image fusion process. A binned version of an image refers to a downscaled version of a captured image, wherein two or more captured pixel values are combined (e.g., via averaging, interpolation, etc.) into a single pixel value in the binned version of the image. For example, a binned version of an image that combines blocks of four individual pixel values (e.g., a 2×2 block of pixel values) into a single, e.g., averaged, pixel value would have the effect of reducing the resolution of the native high-resolution image captured by a factor of four, e.g., a 48 megapixel (MP) image that is binned by a factor of four would result in a 12 megapixel binned image, whereas a 12 megapixel image that is binned by a factor of four would result in a 3 megapixel binned image, and so forth.

Another difference between the exemplary incoming image stream 150 of FIG. 1B and exemplary incoming image stream 100 of FIG. 1A is that exemplary incoming image stream 150 shows the capture of the high-resolution EV− image 109₃ at a thumbnail resolution, i.e., a resolution smaller than the full, high-resolution EV− image 109₂ shown in FIG. 1A. The use of a smaller resolution or “thumbnail” version of the high-resolution EV− image 109₃ (e.g., an image having a resolution that is 2×, 4×, 8×, etc., smaller than the full high-resolution image capture) may be advantageous in several regards. For example, it may still allow for the transfer of higher-dynamic range image capture information to the high-resolution EV0 image 109₁, to create a higher dynamic range high-resolution image to be used in the neural image fusion process, but processing efficiencies may be gained by operating on a thumbnail-sized version of the high-resolution EV− image 109₃ rather than a full-resolution version.

Once the various long exposure and/or synthetic long exposure image assets and/or any desired high-resolution image assets have been created, they may be fused with the other selected images and/or intermediate assets from the incoming image stream (e.g., synthetic reference image 114, which was formed from secondary frame pair 104₃ comprising reference image EV0₃ 112 and EV−₃, in the example illustrated in FIG. 1B), in order to form the final neural fused image 152, e.g., according to any desired neural image fusion techniques, such as those that will be described in greater detail below, with reference to FIGS. 3, 4, and 5.

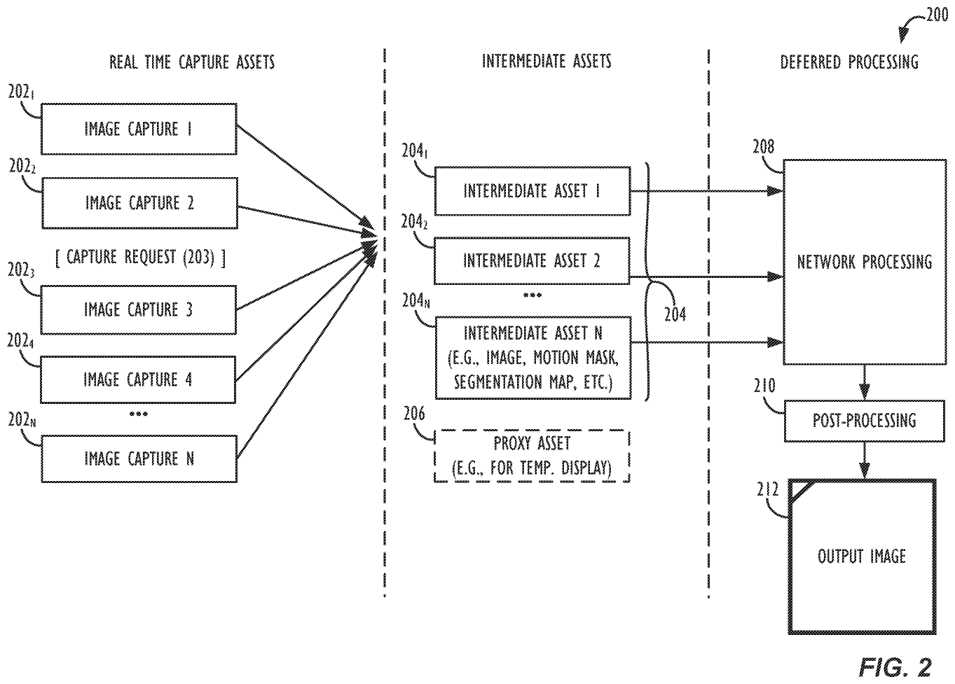

Referring now to FIG. 2, an overview of a process 200 for performing high-resolution and low latency machine learning-enhanced image fusion and/or noise reduction is illustrated, according to one or more embodiments. As described above with reference to FIGS. 1A and 1B, an image capture device may be placed into an image capture mode, whereupon, at an indicated time, a user of the image capture device may issue an image capture request 203, e.g., by the user pressing a shutter button, one or more images (e.g., image captures 202₁-202_{N} in FIG. 2) may be captured by one or more images sensors of the image capture device. Note that, in some implementations, one or more of the image captures 202 may have actually been captured prior to the image capture request 203 (e.g., image captures 202₁ and 202₂), and one or more of the image captures 202 may have been captured after the image capture request 203 (e.g., image captures 202₃ and 202₄). In other implementations, all of the image captures used in the fusion operation may come from prior to (or after) the image capture request. These image captures 202 are referred to herein as “real time” capture assets, indicating that they are obtained at a rate that resembles the frame rate of the video images captured by the image sensor, e.g., 30 fps (subject, of course, to various changes in exposure time for individual bracketed captures, such as to capture the various types of EV− and longer exposure images discussed above with reference to FIGS. 1A and 1B). The image captures 202 may comprise, e.g., one or more of the SFPs 104, high-resolution images 109, and/or long exposure images 108, discussed above with reference to FIGS. 1A and 1B.

According to the embodiments described herein, one or more intermediate assets (e.g., intermediate assets 204₁-204_{N} in FIG. 2) may then be generated, e.g., based on a combination of two or more of the image captures 202. As described above with reference to FIGS. 1A and 1B, according to some embodiments, one intermediate asset, e.g., Intermediate Asset 1 204₁ in FIG. 2, may comprise a synthetic reference image, and another intermediate asset, e.g., Intermediate Asset 2 204₂ in FIG. 2, may comprise a synthetic long image. As will be described in further detail below, other types of intermediate assets are possible as well, e.g., high-resolution synthetic reference images and/or images that are themselves formed via a neural fusion of two or more other intermediate assets (e.g., the neural fusion of a synthetic reference image and a synthetic long image, as described in the '702 patent). Each such intermediate asset may be generated from a determined combination (e.g., a weighted combination) of two or more of the image captures 202. In some embodiments, the intermediate assets may comprise both “image-based” intermediate assets (such as the synthetic reference, high-resolution synthetic reference, and/or synthetic long images described above), as well as “non-image-based” intermediate assets. For example, in some embodiments, non-image-based intermediate assets, such as noise maps representative of the amount of noise (or expected/estimated noise), motion masks (e.g., masks representing areas of predicted motion within a given image or set of aligned images), segmentation maps (e.g., maps distinguishing semantic categories of pixels within an image, such as faces, hair, skin, sky, foliage, etc.), blur maps, etc., may also be generated based on one or more of the image-based intermediate assets that are generated. In some embodiments, in an effort to reduce the overall memory footprint of the fusion operation, the non-image-based intermediate asset (e.g., a motion mask) may intentionally have a lower resolution than the incoming image stream images or the other image-based intermediate assets, and may simply be scaled up (or down) as needed, in order to be applied to or used with the images or other image-based intermediate assets.

As will be explained in further detail below with reference to FIGS. 3, 4, and 5, both the image-based intermediate assets and the non-image-based intermediate assets may be fed into one or more appropriately-trained neural networks, in order to allow the networks to intelligently determine an optimal way to fuse and/or noise reduce the various image-based intermediate assets into a final fused output image that has a higher resolution than the native resolution of at least some of the input image-based assets. In some embodiments, optimal, in this context, may refer to optimality with respect to a specific loss function(s) that was used for training the neural network. Via the training, the neural network result will converge towards minimizing the specific loss function(s). In some instances, the neural network will be trained to generate filter values that may be used to produce a fusion result that simultaneously maintains, to the greatest extent possible, the sharpness from an intermediate asset having the shorter aggregate exposure time (e.g., a synthetic reference image or high-resolution synthetic reference image) and the noise qualities of the intermediate asset having the longer aggregate exposure time (e.g., a synthetic long image or other intermediate asset formed from one or more relatively longer exposure images).

According to some embodiments, the image capture device may also generate one or more so-called proxy assets, based on one or more of the generated intermediate assets. For example, a proxy asset may comprise a quickly or naively-fused version of the image-based intermediate assets. Such a proxy asset may be noisier, blurrier, and/or of a lower resolution than the resultant final fused output image that is generated using the output of a trained neural network, but the proxy asset may serve as a temporary placeholder for a user, i.e., until such time as the proxy asset may be replaced or updated with the final fused output image. In some embodiments, the proxy asset may be provided for display, e.g., via a user interface of the electronic image capture device, prior to completing the generation of the final fused output image.

As mentioned above, according to embodiments disclosed herein, two or more of the intermediate assets 204 may be fed into one or more trained deep neural networks in a configured fashion for neural network-based fusion and/or noise reduction processing 208. In some such embodiments, the output of the network processing 208 may comprise a set of output filters, which filters may be used, e.g., to specify how the corresponding levels of pyramidal decompositions of each image-based intermediate asset should be fused and/or noise reduced to generate the output image.

Based on the aforementioned network output, a fused image may be generated from the image-based intermediate assets. Finally, at block 210, any desired tuning or post-processing may be applied to the fused image, to generate the final fused output image 212. Examples of the types of tuning and post-processing operations that may be performed on the fused image include: sharpening operations, determining a percentage of high-resolution details to be added back in to the fused image (e.g., based on an estimated amount of blurring, luma values, skin/face segmentation regions, etc.), tone mapping, upscaling, downscaling, and/or adjusting the amount of noise reduction applied to the fused image.

Referring now to FIG. 3, an example 300 of a neural network architecture that may be used for performing high-resolution and low latency machine learning-enhanced image fusion and/or noise reduction is illustrated, according to one or more embodiments. As shown in FIG. 3, one or more input image assets 306, e.g., comprising of EV0 images, long exposure images, and/or other types of EV+ images may be combined (e.g., fused or otherwise averaged) to form a synthetic long (SL) image 308, e.g., as described above with regard to synthetic long image 120 in FIG. 1A, which SL image may also be referred to in the context of this embodiment as a fourth intermediate asset. (It is to be understood that modifiers first, second, third, fourth, etc., with respect to the intermediate assets referred to herein are used only to provide syntactic clarity, and do not imply anything regarding an order of operations or a level of importance of the respective intermediate assets, or the like.)

Additionally, as shown in example 300, one or more other input image assets 302, e.g., comprising of EV0 images, EV− images, and/or other types of reference images may be combined (e.g., fused or otherwise averaged) to form a synthetic reference (SR) image 304, e.g., as described above with regard to synthetic reference image 114 in FIG. 1A, which SR image may also be referred to in the context of this embodiment as a third intermediate asset.

As also shown in example 300, one or more other input image assets 310, e.g., comprising of high-resolution EV0 images, high-resolution EV− images, and/or other types of images formed from high resolution image captures (e.g., high-resolution long exposure images, high-resolution thumbnail images and/or binned versions of high-resolution images) may be combined (e.g., fused or otherwise averaged) with SR image 304 to form a so-called “high-resolution synthetic reference (SR) image” 316. As described above, in some embodiments, a high-resolution SR image 316 may be generated via a detail transferring process, wherein the additional detail provided in the high-resolution asset(s) 310 may be transferred over to the SR image 304 according to a motion mask that indicates only those portions of the high-resolution image 310 exhibiting less than a threshold level of estimated motion to corresponding portions of the SR image 304 (since transferring over higher resolution details in portions of the captured scene that do not match well to the reference image would result in unwanted artifacts). In some implementations, the motion mask may be computed via a Gaussian and/or Laplacian pyramid decomposition process that is refined at each level of the pyramid, in order to maximize the amount of detail transfer that can take place. The high-resolution SR image 316 may also be referred to in the context of this embodiment as a second intermediate asset 324.

In some embodiments, e.g., depending on their respective native resolutions or the power/memory/processing constraints of a given implementation, it may be desirable (or necessary) to downscale (at block 312) the high-resolution asset(s) 310 all the way down (or part of the way down) to the native resolution of the SR image 304 before commencing the process of generating the high-resolution SR image 316. In some such embodiments, it may be desirable (or necessary) to upscale (at block 314) the SR image 304 all the way up (or part of the way up) to the native resolution of the high-resolution asset 310 before commencing the process of generating the high-resolution SR image 316. As one example, if the SR image 304's native resolution is at 12 MP and the high-resolution asset 310's native resolution is at 48 MP, then, in one embodiment, the SR image 304 may be upscaled at block 314 by a factor of 2× to an upscaled resolution of 24 MP, while the high-resolution asset 310 may be downscaled at block 312 by a factor of 2× to an downscaled resolution of 24 MP. Matching resolutions before commencing the process of generating the high-resolution SR image 316 may result in a more effective and efficient detail transfer process, with the resulting high-resolution SR image still having a greater resolution than the SR image 304 (even if not at the full native resolution of the high-resolution asset 310).

Returning to example 300, the SL image 308 and the SR image 304 may be combined via a neural fusion process at network processing block (labeled “NET 0” for ease of illustration purposes) 318. For example, the NET 0 applied at network processing block 318 may comprise the neural fusion network described in the '702 patent, or other suitably-trained neural network architecture for fusing two intermediate assets having different characteristics. The fused output image generated by network processing block 318 may also be referred to in the context of this embodiment as a first intermediate asset 322. In some embodiments, this first intermediate asset may also optionally be upscaled (at block 320), e.g., if there is a desire (or need) to match the resolution of the high-resolution SR image (i.e., second intermediate asset 324) before being fed into the high-resolution network processing block (labeled “NET 1” for ease of illustration purposes) 326. For example, the NET 1 applied at network processing block 326 may comprise a neural fusion network trained to fuse two intermediate assets having different characteristics. In particular, NET 1 326 may be trained to fuse the second intermediate asset, i.e., the high-resolution SR image 316 (which may comprise a relatively noisy—but high resolution-representation of the captured scene at the moment intended by the photographer), with the first intermediate asset, i.e., the fused output image generated by network processing block 318 (which may comprise a relatively clean, i.e., not noisy—but lower resolution-representation of the captured scene at the moment intended by the photographer), in order generate a denoised version of the high-resolution SR image 316 that represents the captured scene at the desired higher resolution level. The output of NET 1 326 is thus shown in FIG. 3 as the generated high-resolution output image 328.

Because the example network 300 utilizes an SR image that may be generated from images having relatively shorter exposure times (e.g., EV− images) in the creation of both the first intermediate asset and the second intermediate asset, in some embodiments, the exemplary network 300 may be selected by an image capture device for use in fusion operations when the device is capturing in low-lighting image capture scenarios (e.g., between 10 lux and 1,000 lux). As will be explained in further detail below, different network architectures may be possible to use while still producing satisfactory fused image results, e.g., depending on scene lux or other factors.

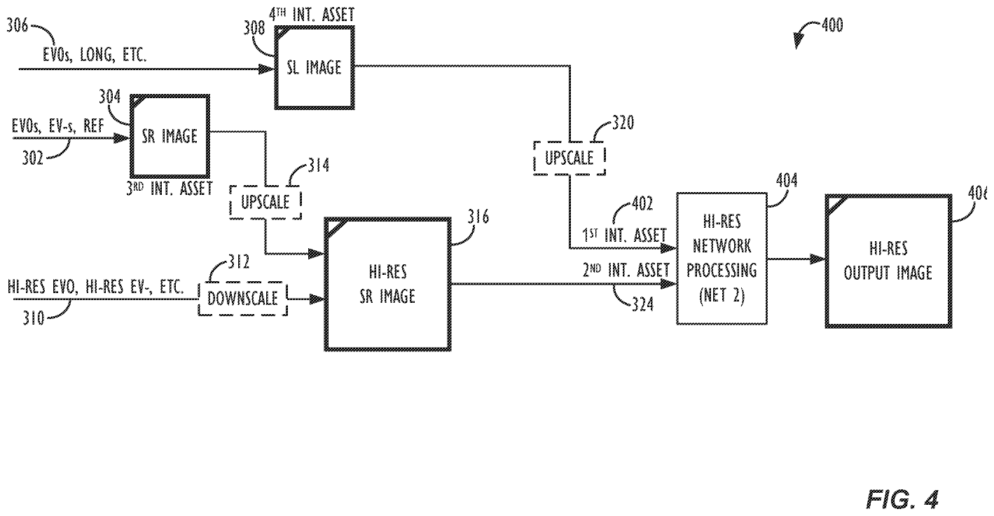

Referring now to FIG. 4, another example 400 of a neural network architecture that may be used for performing high-resolution and low latency machine learning-enhanced image fusion and/or noise reduction, according to one or more embodiments. Compared with the neural network architecture 300 shown in FIG. 3, the example neural network architecture 400 does not utilize the network processing block 318 (i.e., NET 0). Instead, the SL image 308 is optionally upscaled at block 320 and then provided directly (as the first intermediate asset 402) to a high-resolution network processing block (labeled “NET 2” for ease of illustration purposes) 404. For example, the NET 2 applied at network processing block 404 may comprise a neural fusion network trained to fuse two intermediate assets having different characteristics. In particular, NET 2 404 may be trained to fuse the second intermediate asset, i.e., the high-resolution SR image 316 (which may comprise a relatively noisy—but high resolution-representation of the captured scene at the moment intended by the photographer), with the first intermediate asset, i.e., an optionally upscaled SL image 308 (which may comprise a relatively clean, i.e., not noisy—but lower resolution-representation of the captured scene at the moment intended by the photographer), in order generate a denoised version of the high-resolution SR image 316 that represents the captured scene at the desired higher resolution level. The output of NET 2 404 is thus shown in FIG. 4 as the generated high-resolution output image 406.

Because the SL image 308 is used directly at NET 2 block 404 (i.e., with no further neural denoising and/or fusion), in some embodiments, to ensure that SL image 308 is sufficiently clean (i.e., noise-free), the exemplary network 400 may be selected by an image capture device for use in fusion operations only when the device is capturing in sufficiently bright lighting image capture scenarios (e.g., scenes having greater than 1,000 lux).

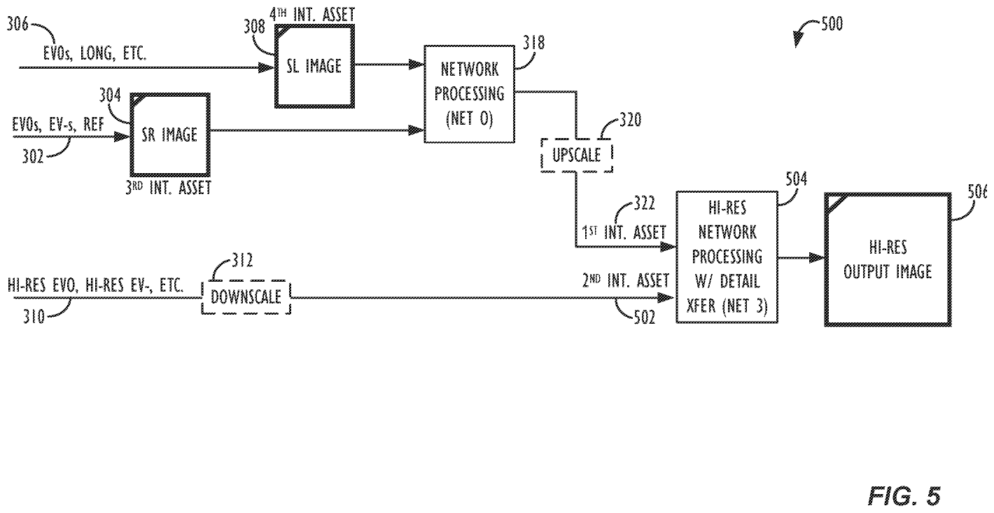

Referring now to FIG. 5, yet another example 500 of a neural network architecture that may be used for performing high-resolution and low latency machine learning-enhanced image fusion and/or noise reduction, according to one or more embodiments. Compared with the neural network architectures 300 and 400 shown in FIGS. 3 and 4, respectively, the example neural network architecture 500 does not employ the use of high-resolution SR image 316. Instead, example network 500 comprises a high-resolution network processing block (labeled “NET 3” for ease of illustration purposes) 504. For example, the NET 3 applied at network processing block 504 may comprise a neural fusion network trained to fuse two intermediate assets having different characteristics. The first intermediate asset may comprise first intermediate asset 322 (as first introduced above with regard to FIG. 3, as being the result of a neural fusion of an SR image and an SL image), and the second intermediate asset 502 may simply comprise an optionally downscaled (at block 312) version of the high-resolution asset 310.

As may now be understood, rather than using an image processing-based method (e.g., pyramidal decomposition or other methods) to develop a motion mask indicating the portions where the high-resolution asset exhibits sufficiently little motion with respect to the lower-resolution reference or synthetic reference image that it is safe to transfer high-resolution details to the lower-resolution reference or synthetic reference image, it is instead the NET 3 504 that is itself trained to transfer the higher-resolution details from the second intermediate asset 502 to the first intermediate asset 322 to generate the high-resolution output image 506.

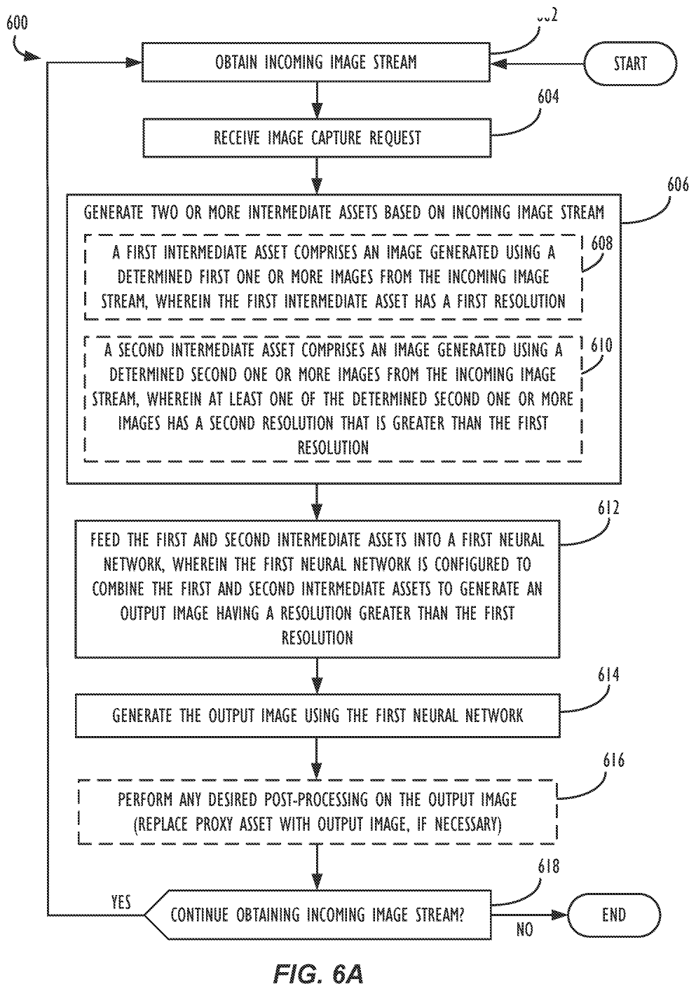

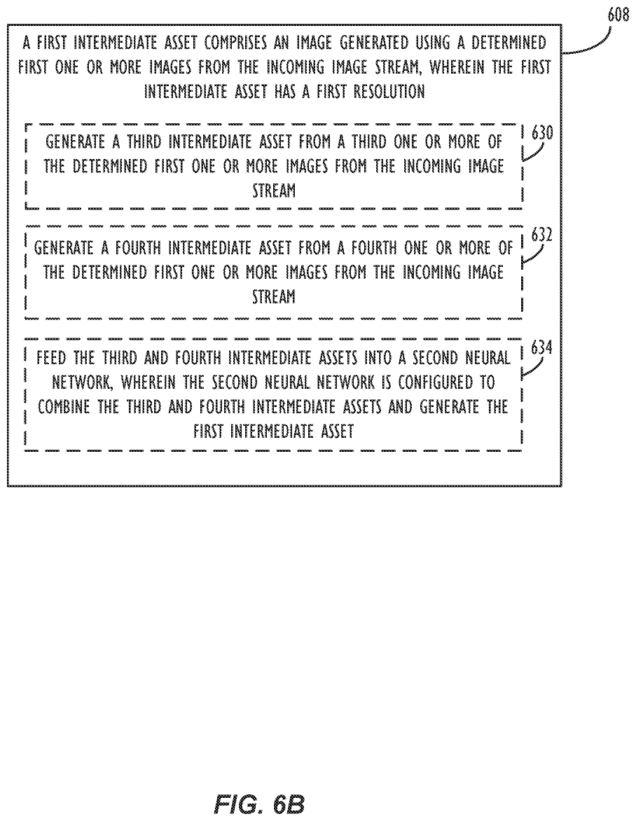

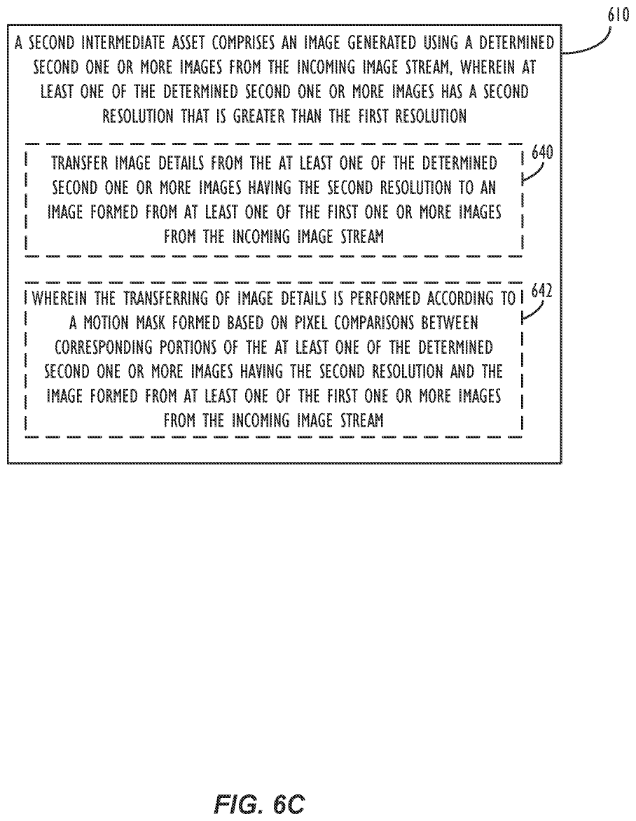

Referring now to FIG. 6A, a flow chart illustrating a method 600 of performing high-resolution and low latency machine learning-enhanced image fusion and/or noise reduction using one or more intermediate assets is shown, according to one or more embodiments. The method 600 may begin at Step 602 by obtaining an incoming image stream (e.g., image stream 100 of FIG. 1A). Next, at Step 604, the method 600 may receive an image capture request (e.g., image capture request 106 of FIG. 1A). In response to the image capture request, at Step 606, the method 600 may generate two or more intermediate assets based on the incoming image stream. As described above, the generated intermediate assets may include image-based and/or non-image-based intermediate assets. The image-based intermediate assets may be generated using one or more images from the incoming image stream, wherein the images used in a given intermediate asset could come from immediately prior to the capture request, up to an including a threshold number of images captured prior to the capture request (e.g., depending on how many prior captured images an image capture device may be able to continue to hold in memory), and/or one or more images that are captured after receiving the image capture request (e.g., the high-resolution images 109 or the long exposure image 108 of FIG. 1A). In some embodiments, a first intermediate asset may be generated using a determined first one or more images from the incoming image stream, wherein the first intermediate asset has a first resolution (Step 608), and a second intermediate asset may be generated using a determined second one or more images from the incoming image stream, wherein at least one of the determined second one or more images has a second resolution that is greater than the first resolution (Step 610).

At Step 612, the method 600 may feed the first and second intermediate assets into a first neural network, wherein the first neural network is configured to combine the first and second intermediate assets to generate an output image having a resolution greater than the first resolution. According to some embodiments, the first neural network may be configured to generate a set of output filters comprising multiple channels, which filters may be used to de-ghost (i.e., fuse) and denoise each of the levels of a pyramidal representation of the output image that is generated from the corresponding levels of the aforementioned two or more generated intermediate assets.

At Step 614, the output filters for a given layer of the first neural network may be used on (or applied to) the image data of the corresponding levels of the pyramidal representations of the two or more generated intermediate assets, e.g., thereby generating a fused and/or noise-reduced pyramidal representation that may be collapsed to generate the fused output image. If desired, at Step 616, optional post-processing and/or tuning may be performed on the filtered image to generate the final fused output image. At that point, if a proxy asset were generated (e.g., a temporary image created for display during the fusion process), it could be updated or replaced with the final fused output image from Step 614. At Step 618, if the image capture device has been directed, e.g., by a user, to continue obtaining an incoming image stream (i.e., “YES” at Step 618), the method 600 may return to Step 602. If, instead, the image capture device has been directed, e.g., by a user, to stop obtaining an incoming image stream (i.e., “NO” at Step 618), the method 600 may terminate.

Turning now to FIG. 6B, a flow chart illustrating additional details related to Step 608 of method 600 is shown, according to one or more embodiments. In particular, in some cases, the first intermediate asset may be formed by: generating a third intermediate asset (e.g., a synthetic reference image) from a third one or more of the determined first one or more images from the incoming image stream (Step 630); generating a fourth intermediate asset (e.g., a synthetic long image) from a fourth one or more of the determined first one or more images from the incoming image stream (Step 632); and feeding the third and fourth intermediate assets into a second neural network (e.g. such as the neural networks described in the '702 patent), wherein the second neural network is configured to combine the third and fourth intermediate assets and generate the first intermediate asset having the first resolution (Step 634).

Turning now to FIG. 6C, a flow chart illustrating additional details related to Step 610 of method 600 is shown, according to one or more embodiments. In particular, in some cases, the second intermediate asset may be formed by transferring image details from the at least one of the determined second one or more images having the second resolution to an image formed from at least one of the first one or more images from the incoming image stream (Step 640), wherein the transferring of image details is performed according to a motion mask formed based on pixel comparisons between corresponding portions of the at least one of the determined second one or more images having the second resolution and the image formed from at least one of the first one or more images from the incoming image stream (Step 642). As described above, in some embodiments, it may be desirable to only transfer image details from second one or more images in regions of the captured scene that exhibit less than a threshold level of estimated motion.

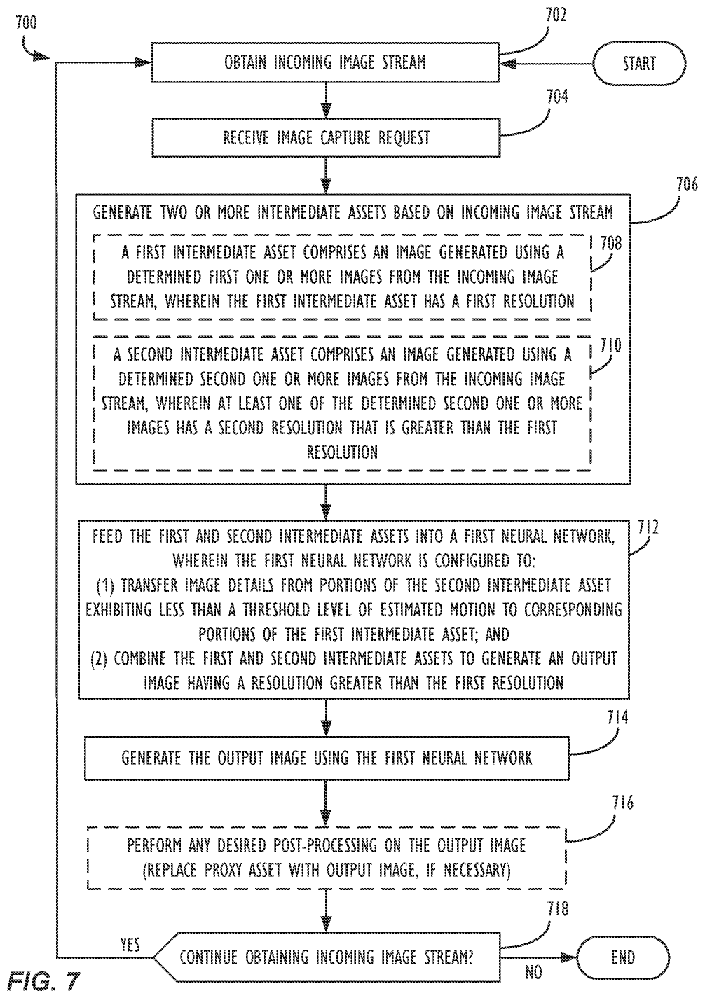

Referring now to FIG. 7, a flow chart illustrating another method 700 of performing high-resolution and low latency machine learning-enhanced image fusion and/or noise reduction using one or more intermediate assets is shown, according to one or more embodiments. The method 700 may begin at Step 702 by obtaining an incoming image stream (e.g., image stream 100 of FIG. 1A). Next, at Step 704, the method 700 may receive an image capture request (e.g., image capture request 106 of FIG. 1A). In response to the image capture request, at Step 706, the method 700 may generate two or more intermediate assets based on the incoming image stream. In some embodiments, a first intermediate asset may be generated using a determined first one or more images from the incoming image stream, wherein the first intermediate asset has a first resolution (Step 708), and a second intermediate asset may be generated using a determined second one or more images from the incoming image stream, wherein at least one of the determined second one or more images has a second resolution that is greater than the first resolution (Step 710).

At Step 712, the method 700 may feed the first and second intermediate assets into a first neural network, wherein the first neural network is configured to: (1) transfer image details from portions of the second intermediate asset exhibiting less than a threshold level of estimated motion to corresponding portions of the first intermediate asset; and (2) combine the first and second intermediate assets to generate an output image having a resolution greater than the first resolution. Neural networks such as those referred to in Step 712 are described in greater detail above, e.g., with reference to FIG. 5 and network 504.

At Step 714, the output filters for a given layer of the first neural network may be used on (or applied to) the image data of the corresponding levels of the pyramidal representations of the two or more generated intermediate assets, e.g., thereby generating a fused and/or noise-reduced pyramidal representation that may be collapsed to generate the fused output image. If desired, at Step 716, optional post-processing and/or tuning may be performed on the filtered image to generate the final fused output image. At that point, if a proxy asset were generated (e.g., a temporary image created for display during the fusion process), it could be updated or replaced with the final fused output image from Step 714.

At Step 718, if the image capture device has been directed, e.g., by a user, to continue obtaining an incoming image stream (i.e., “YES” at Step 718), the method 700 may return to Step 702. If, instead, the image capture device has been directed, e.g., by a user, to stop obtaining an incoming image stream (i.e., “NO” at Step 718), the method 700 may terminate.

Exemplary Electronic Computing Devices

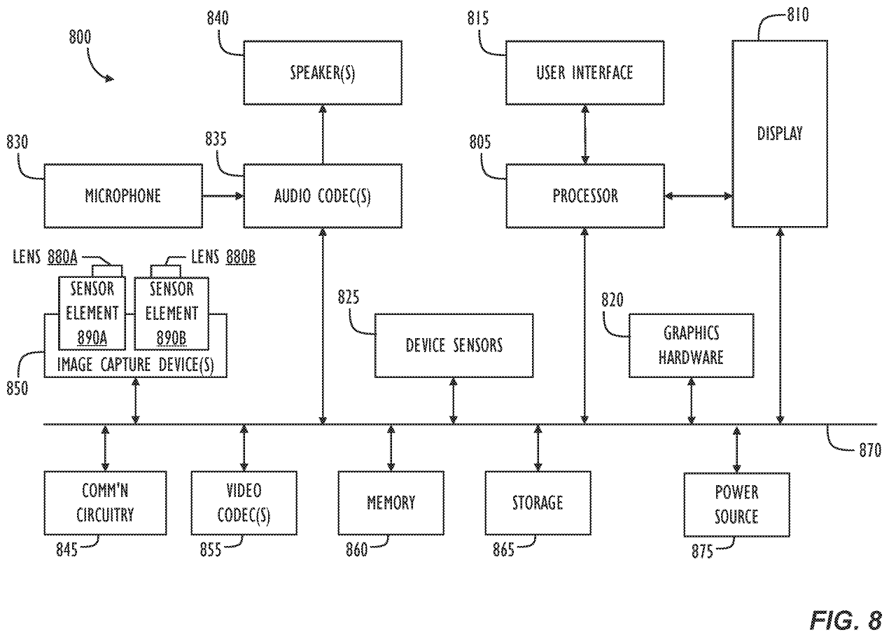

Referring now to FIG. 8, a simplified functional block diagram of illustrative programmable electronic computing device 800 is shown according to one embodiment. Electronic device 800 could be, for example, a mobile telephone, personal media device, portable camera, or a tablet, notebook or desktop computer system. As shown, electronic device 800 may include processor 805, display 810, user interface 815, graphics hardware 820, device sensors 825 (e.g., proximity sensor/ambient light sensor, accelerometer, inertial measurement unit, and/or gyroscope), microphone 830, audio codec(s) 835, speaker(s) 840, communications circuitry 845, image capture device(s) 850, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 855, memory 860, storage 865, and communications bus 880.

Processor 805 may execute instructions necessary to carry out or control the operation of many functions performed by electronic device 800 (e.g., such as the generation and/or processing of images in accordance with the various embodiments described herein). Processor 805 may, for instance, drive display 810 and receive user input from user interface 815. User interface 815 can take a variety of forms, such as a button, keypad, dial, a click wheel, keyboard, display screen and/or a touch screen. User interface 815 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 810 may display a video stream as it is captured while processor 805 and/or graphics hardware 820 and/or image capture circuitry contemporaneously generate and store the video stream in memory 860 and/or storage 865. Processor 805 may be a system-on-chip (SOC) such as those found in mobile devices and include one or more dedicated graphics processing units (GPUs). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 perform computational tasks. In one embodiment, graphics hardware 820 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 850 may comprise one or more camera units configured to capture images, e.g., images which may be processed to help further calibrate said image capture device in field use, e.g., in accordance with this disclosure. Image capture device(s) 850 may include two (or more) lens assemblies 880A and 880B, where each lens assembly may have a separate focal length. For example, lens assembly 880A may have a shorter focal length relative to the focal length of lens assembly 880B. Each lens assembly may have a separate associated sensor element, e.g., sensor elements 890A/890B. Alternatively, two or more lens assemblies may share a common sensor element. Image capture device(s) 850 may capture still and/or video images. Output from image capture device(s) 850 may be processed, at least in part, by video codec(s) 855 and/or processor 805 and/or graphics hardware 820, and/or a dedicated image processing unit or image signal processor incorporated within image capture device(s) 850. Images so captured may be stored in memory 860 and/or storage 865.

Memory 860 may include one or more different types of media used by processor 805, graphics hardware 820, and image capture device(s) 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805, such computer program code may implement one or more of the methods or processes described herein. Power source 875 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 800.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A device, comprising:
a memory;
one or more image capture devices;
a user interface; and
one or more processors operatively coupled to the memory, wherein the one or more processors are configured to execute instructions causing the one or more processors to:
obtain an incoming image stream from the one or more image capture devices;
receive an image capture request via the user interface;
generate, in response to the image capture request, two or more intermediate assets, wherein:
a first intermediate asset of the generated two or more intermediate assets comprises an image generated using a determined first one or more images from the incoming image stream, and wherein the first intermediate asset has a first resolution; and
a second intermediate asset of the generated two or more intermediate assets comprises an image generated using a determined second one or more images from the incoming image stream, wherein at least one of the determined second one or more images has a second resolution, and wherein the second resolution is greater than the first resolution;
feed the first and second intermediate assets into a first neural network, wherein the first neural network is configured to combine the first and second intermediate assets to generate an output image having a resolution greater than the first resolution; and
generate the output image using the first neural network.

2. The device of claim 1, wherein generating the second intermediate asset further comprises:
transferring image details from the at least one of the determined second one or more images having the second resolution to an image formed from at least one of the first one or more images from the incoming image stream.

3. The device of claim 2, wherein the transferring of image details is performed according to a motion mask formed based on pixel comparisons between corresponding portions of the at least one of the determined second one or more images having the second resolution and the image formed from at least one of the first one or more images from the incoming image stream.

4. The device of claim 2, wherein the at least one of the determined second one or more images having the second resolution is downscaled before transferring image details to the image formed from at least one of the first one or more images from the incoming image stream.

5. The device of claim 4, wherein the image formed from at least one of the first one or more images from the incoming image stream is upscaled to match the downscaled resolution of the at least one of the determined second one or more images before the image details are transferred to the image formed from at least one of the first one or more images from the incoming image stream.

6. The device of claim 1, wherein generating the first intermediate asset further comprises:
generating a third intermediate asset from a third one or more of the determined first one or more images from the incoming image stream;
generating a fourth intermediate asset from a fourth one or more of the determined first one or more images from the incoming image stream; and
feeding the third and fourth intermediate assets into a second neural network, wherein the second neural network is configured to combine the third and fourth intermediate assets and generate the first intermediate asset.

7. The device of claim 6, wherein the third intermediate asset is sharper than the fourth intermediate asset.

8. The device of claim 7, wherein the fourth intermediate asset is less noisy than the third intermediate asset.

9. The device of claim 6, wherein the first intermediate asset is upscaled to match the resolution of the second intermediate asset before the first neural network combines the first and second intermediate assets to generate the output image having a resolution greater than the first resolution.

10. The device of claim 1, wherein the incoming image stream comprises images with two or more different exposure values.

11. The device of claim 1, wherein the determined first one or more images from the incoming image stream comprise: two or more images obtained from the incoming image stream prior to receiving the image capture request.

12. The device of claim 11, wherein the determined second one or more images from the incoming image stream comprise: one or more images obtained from the incoming image stream after receiving the image capture request.

13. A non-transitory program storage device comprising instructions stored thereon to cause one or more processors to:
obtain an incoming image stream from one or more image capture devices;
receive an image capture request;
generate, in response to the image capture request, two or more intermediate assets, wherein:
a first intermediate asset of the generated two or more intermediate assets comprises an image generated using a determined first one or more images from the incoming image stream, and wherein the first intermediate asset has a first resolution; and
a second intermediate asset of the generated two or more intermediate assets comprises an image generated using a determined second one or more images from the incoming image stream, wherein at least one of the determined second one or more images has a second resolution, and wherein the second resolution is greater than the first resolution;
feed the first and second intermediate assets into a first neural network, wherein the first neural network is configured to:
(1) transfer image details from portions of the second intermediate asset exhibiting less than a threshold level of estimated motion to corresponding portions of the first intermediate asset; and
(2) combine the first and second intermediate assets to generate an output image having a resolution greater than the first resolution; and
generate the output image using the first neural network.

14. The non-transitory program storage device of claim 13, wherein the second intermediate asset is downscaled before being fed into the first neural network.

15. The non-transitory program storage device of claim 14, wherein the first intermediate asset is upscaled to match the downscaled resolution of the second intermediate asset before being fed into the first neural network.

16. The non-transitory program storage device of claim 13, wherein generating the first intermediate asset further comprises:
generating a third intermediate asset from a third one or more of the determined first one or more images from the incoming image stream;
generating a fourth intermediate asset from a fourth one or more of the determined first one or more images from the incoming image stream; and
feeding the third and fourth intermediate assets into a second neural network, wherein the second neural network is configured to combine the third and fourth intermediate assets and generate the first intermediate asset.

17. The non-transitory program storage device of claim 16, wherein the third intermediate asset is sharper than the fourth intermediate asset.

18. The non-transitory program storage device of claim 17, wherein the fourth intermediate asset is less noisy than the third intermediate asset.

19. The non-transitory program storage device of claim 13,
wherein the determined first one or more images from the incoming image stream comprise two or more images obtained from the incoming image stream prior to receiving the image capture request, and
wherein the determined second one or more images from the incoming image stream comprise: one or more images obtained from the incoming image stream after receiving the image capture request.

20. An image processing method, comprising:
obtaining an incoming image stream from one or more image capture devices;
receiving an image capture request;
generating, in response to the image capture request, two or more intermediate assets, wherein:
a first intermediate asset of the generated two or more intermediate assets comprises an image generated using a determined first one or more images from the incoming image stream, and wherein the first intermediate asset has a first resolution; and
a second intermediate asset of the generated two or more intermediate assets comprises an image generated using a determined second one or more images from the incoming image stream, wherein at least one of the determined second one or more images has a second resolution, and wherein the second resolution is greater than the first resolution;
feeding the first and second intermediate assets into a first neural network, wherein the first neural network is configured to combine the first and second intermediate assets to generate an output image having a resolution greater than the first resolution; and
generating the output image using the first neural network.
